(19) United States
(12) Patent Application Publication
(10) Pub. No.: US 2007/0126242 A1
(43) Pub. Date: Jun. 7, 2007

(54) Vehicle door lock

(76) Inventors: Susanne Adrian-Gulpinarli, Gelsenkirchen (DE); Karsten Barth, Bochum (DE); Thorsten Bendel, Oberhausen (DE); Stefan Ebersohn, Boblingen (DE); Serkan Gulkan, Castrop-Rauxel (DE); Martin Lindmayer, Sulz-Hopfau (DE)

Correspondence Address: WILLIAM COLLARD;COLLARD & ROE, P.C., 1077 NORTHERN BOULEVARD, ROSLYN, NY, 11576, US

(21) Appl. No.: 10/566,325

(22) PCT Filed: Dec. 24, 2004
(86) PCT No.: PCT/DE04/02813

§ 371 Date: Jan. 26, 2006

(30) Foreign Application Priority Data
Jan. 20, 2004 (DE) 102004002756.0

(51) Int. Cl. E05C 3/06

(52) U.S. Cl. 292/201

(57) ABSTRACT

The invention relates to a vehicle door lock comprising a housing and functional elements that are situated inside the housing, the elements being used for the following: a) a hand actuation of the lock by means of actuating elements that are mounted on the interior and exterior of the door; b) a central locking system that can be activated and operated either manually or by means of a motor; and c) alternatively cl) either a motor-operated door opening aid or c2) a unit, which is used to switch the actuating elements on the interior of the door into an inactive state, in which the actuating elements prevent the opening of the lock. One of the aims of the invention is to enable the lock to be produced in an efficient manner in both of the alternative embodiments. To achieve this, the two embodiments use a housing with an identical unmodified form and drive motors (3) that are identically. configured and arranged, and different force transmission elements are inserted into partly common installation spaces (1) in the common housing (1) and/or into receiving and/or connecting elements (4) that are situated on identical, common functional elements.

The invention relates to a vehicle door lock according to the preamble of Patent claim 1.

The alternative lock designs mentioned are desired in practice depending on the type of vehicle to be equipped with them as options.

Based on this problem which exists in practice, the invention relates to the problem of making these two embodiments available for mass production demand as economically and thus as inexpensively as possible. This is true in particular of applications in which one of the two alternative embodiments available is needed in a relatively small number of parts in comparison with the other embodiment.

This problem is solved by an embodiment of a generic vehicle door lock according to the characterizing feature of Patent Claim 1.

Advantageous and expedient embodiments are the subject of the dependent claims.

This invention is based on the general idea of designing the function elements of the lock which are necessary for both alternative cases and arranging them in a lock housing so that the greatest possible number of identical parts can be used for both alternative embodiments. This is achieved by the fact that exactly the same lock housing can be used for both embodiments. For different function elements for the two alternative embodiments, spaces are provided in the same housing into which the different function elements can be inserted replaceably. If additional elements must also be used for one of the two embodiments in addition to replaceable elements, free spaces are provided for them accordingly in the housing. In addition, connecting elements for other function elements are always provided in the same way on jointly used function elements, even if these other connecting elements are used only in one of the two embodiments. If possible, the same bearing axles which are provided in the housing are also provided for force transmission means that are used in different ways depending on the alternative embodiment. In particular, the drive motors which are necessary for both embodiments are designed and arranged in such a way that they assume the same installed space within the lock housing in both cases.

A particularly advantageous exemplary embodiment which is explained in greater detail below is depicted in the drawing.

The drawing shows a view of a vehicle lock with the housing opened in a schematic diagram, namely

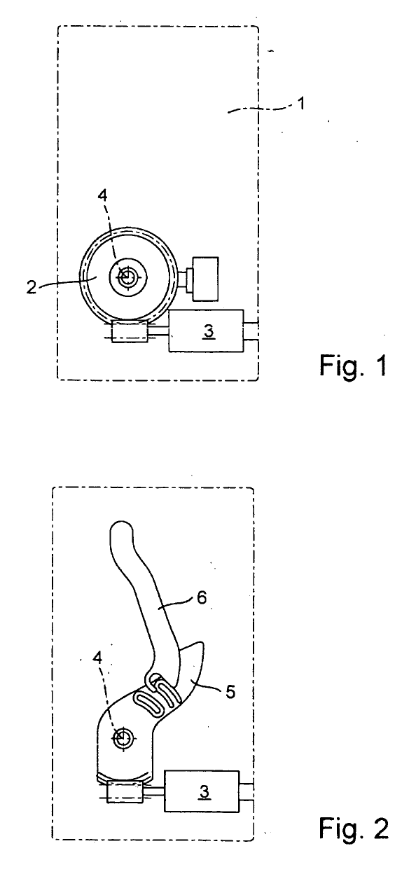

FIG. 1 an embodiment with a motorized door opening aid,

FIG. 2 an embodiment with an inactivation device for the lock actuating means on the inside of the door as an alternative embodiment to the embodiment according to FIG. 1.

The two embodiments according to FIGS. 1 and 2 have the same lock housing 1 and the same function elements with regard to the basic functions common to the two embodiments.

For the embodiment according to FIG. 1 having a motorized door opening aid, a step-down gear wheel 2 is provided in the lock, serving as a force transmission means between an electric servomotor 3 and an actuator device for the door opening aid. This gear wheel 2 is mounted in an axis of rotation 4 in a rigid mount on the housing. In the alternative embodiment according to FIG. 2, no door opening aid is provided. Therefore, the gear wheel 2 which is necessary in the embodiment according to FIG. 1 there is omitted. A first lever 5 is pivotably mounted on the same axis of rotation 4 in the housing space which has become free due to the elimination of the gear wheel 2. Like the gear wheel 2, this lever 5 is driven by a servomotor 3, which has remained unchanged in comparison with the embodiment according to FIG. 1, to which end the first lever 5 has a toothed section with gear teeth corresponding to those of the gear wheel 2. In this way, this first lever 5 can be adjusted by a worm wheel of the servomotor 3 in the same way as the gear wheel 2. The first lever 5 operates a clutch by which the lock actuating means on the inside of the door, which can be operated by hand, is switched to inactive.

To prevent the lock from not being openable when there is a disturbance in the drive of the servomotor 3 which may occur, for example, due to a discharged battery, the lock cannot be opened because of inactivated lock actuating means-actuated by the electric motor-driven first lever 5 -a second lever 6, which is in operative connection with the first lever 5, is provided in the lock. This second lever 6 is necessarily shifted by operation of the lock from the outside by a mechanical key, for example, so that due to its operative connection with the first lever 5, this first lever 5 overrides the inactivation of the actuating means.

Control means for the second lever 6 are provided on the lock actuating means which are moved by a lock actuation from the outside of the door, for example, and which are present in both alternative embodiments according to FIGS. 1 and 2, regardless of which of the two alternative embodiments is implemented in each case. Thus, one embodiment according to FIG. 1 has all the prerequisites for being able to use the second lever 6 in operative connection with a first lever 5 provided there with no problem without having to take any other particular measures in an alternative embodiment according to FIG. 2.

For a clear and distinct understanding of this invention, essentially only the different function elements and the servomotors which are the same for the two different function elements are depicted in the drawing, while the remainder of the lock is indicated only by a border shown with a dash-dot line.

1. A lock for a vehicle door having a housing and function elements arranged inside this housing
a) for manual operation of the lock via operating means arranged on the inside and outside of the door,
b) for a central lock system which can be operated optionally either by motor drive or by manual operation, and
c) alternatively
c1) either for a motor-operated door opening aid or
c2) for a device with which the operating means on the inside of the door can be shifted to an inactive state in which these operating means do not allow opening of the lock,
wherein
for the alternative embodiments according to features c1) or c2), different force transmission means (2; 5) can be used interchangeably in the same unmodified housing (1) with drive motors that are arranged and configured the same, the only difference is that different force transmission means (2; 5) are used in the common housing and/or on the receiving and/or connecting elements provided on the same jointly usable function elements.

2. The lock according to claim 1, wherein
the force transmission means that are interchangeably usable for the door opening and/or closing aid include a step-down gear wheel (2) that is supportable so it can rotate about an axis of rotation (4) provided in the housing (1) for the door opening and/or closing aid.

3. The lock according to claim 1, wherein
the force transmission means that are interchangeably usable include a first lever (5) for inactivating the actuating means on the inside of the door, whereby the pivot axis of the first lever on the housing end corresponding to the axis of rotation (4) of the step-down gear wheel (2) in the alternative embodiment, this first lever (5) having an engagement in an identical drive pinion of an identical drive motor (3), said engagement matching the gear teeth of the step-down gear wheel (2).

4. The lock according to claim 1, wherein
the manually operable lock operating means on the lock include a second lever (6), which is in operative connection with the first lever (5), motor-operated inactivation of the operating means on the inside of the door being cancelable by manual operation of said second lever.
